(19) United States
(12) Patent Application Publication
(10) Pub. No.: US 2008/0274224 A1
(43) Pub. Date: Nov. 6, 2008

(54) Precompression Pin Shut Off with Suckback

(75) Inventors: Josef GRAETZ, Erin (CA); Douglas James WEATHERALL, Bolton (CA); Giuseppe Edwardo MARICONDA, Newmarket (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/744,704

(22) Filed: May 4, 2007

(51) Int. Cl. B29C 45/23; B29C 47/36

(52) U.S. Cl. 425/148; 425/382.4; 425/563; 425/564

(57) ABSTRACT

An injection nozzle is provided having a nozzle body, defining an inlet channel, an outlet channel and a connecting channel therebetween for communicating a working fluid into and out of the nozzle body. A shut-off pin is slidably mounted within the nozzle body and having a spigot mounted thereto. The shut-off pin is movable between a closed position, where the working fluid is substantially blocked from moving from the inlet channel to the outlet channel, and an open position where the spigot is withdrawn, unblocking the working fluid from moving from the inlet channel to the outlet channel. An actuator is operably connected to the shut-off pin to move the shut-off pin from the open position to the closed position. Moving the shut-off pin from the open position to the closed position generates a region of low pressure in the working fluid in the portion of working fluid trailing the spigot.

### FIELD OF INVENTION

The present invention generally relates to molding systems; more specifically, the present invention relates to precompression pin shut off with suckback of a molding system. A spigot-style pin shut off machine nozzle facilitates a molding cycle that contains either a precompression portion, a suckback portion or both.

### BACKGROUND OF INVENTION

The injection molding process usually comprises preparing a polymeric material in an injection unit of an injection molding machine, injecting the material under pressure into a closed and clamped mold that is water cooled, solidifying the material in its molded shape, opening the mold and ejecting the part before beginning the next cycle.

In some cases it is advantageous to precompress the molding material prior to injecting it into the mold. This known process is called precompression molding.

In some cases it is advantageous to create a relatively low pressure in the machine nozzle after injection and hold have been completed in order to decompress the mold's hot runner system and to minimize drooling of the material if the machine nozzle is separated from the mold at some point in the molding cycle. This process is called suckback.

Precompression Molding

Precompression molding was created as a solution to the problem of filling a thin walled mold cavity fast enough to complete the filling before the cooling of the molding material impeded the flow of the material to the furthest extremities of the mold cavity. It consists of compressing the molding material prior to allowing it to flow into the mold cavity, thus once released the stored energy in the precompressed melt helps propel it very quickly to fill the mold cavity.

U.S. Pat. No. 4,386,903 to Wybenga teaches a precompression nozzle in which a sliding pin contains a flow channel that remains closed by springs urging the pin forward in the machine nozzle tip. After the molding material has been compressed in the injection unit the unit is advanced so that the exposed pin head is caused to compress the springs and open the flow channel to allow the precompressed material to flow into the mold. A disadvantage is that the entire injection unit of the machine must advance and retract during each molding cycle to activate the valve.

U.S. Pat. No. 6,680,012 to Pokorny teaches a pin shut off nozzle which is held closed by a lever so that molding material can be compressed in an antechamber in the injection unit. At a predetermined pressure level in the antechamber the lever is moved to allow the pin to open the nozzle and allow the compressed material to flow into the mold by expansion alone. There is no teaching of a spigot-style pin shut off.

US 2004/0109918 to Lind teaches a pin shut off nozzle that has a controllable active closure for the nozzle opening and closing. The pin opens the flow channel at a predetermined pressure value for the precompressed molding material and is closed by a lever at the end of the injection-hold phase of the molding cycle. There is no teaching of a spigot-style pin shut off.

Suckback

Hot runner molds include a heated melt distribution system which conveys the molding material from the machine injection unit through multiple channels in the hot runner manifold so that material can be distributed to each of several hot runner nozzles or drops. The mold may include multiple cavities each served by one drop, or it may include a single large cavity served by several drops located about its surface. After the mold has been filled with the material it may be necessary to reduce the pressure of the material remaining in the hot runner system so that it will not drool out of the drops after the mold has been opened or after the machine nozzle has been disengaged from the hot runner system inlet port. This pressure reduction, or decompression, is usually achieved by creating a lower pressure in the machine's injection unit, usually by retracting the feedscrew or injection plunger, to “suckback” the material from mold's hot runner system prior to mold opening or nozzle disengagement.

U.S. Pat. No. 4,632,652 to Farrell teaches a draw-back valve assembly that provides a suction action in the machine injection unit nozzle during part of the molding cycle.

U.S. Pat. No. 4,812,268 to Kamiguchi teaches a control method for an injection molding machine to cause the feedscrew to retract during part of the molding cycle to provide a suckback function.

U.S. Pat. No. 5,065,910 to Fiedler teaches and dispenser head having a feature which causes material in the discharge opening to be sucked back into a chamber. This is not an injection molding device.

U.S. Pat. No. 6,348,171 to Dewar teaches a drool control apparatus for the sprue bars of an injection mold in which opposed shut off pins close the melt channel prior to their separation thereby minimize drool.

Spigot-Style Shut Off Pin

A spigot-style shut off pin is one in which the pin slides within a closely fitting bore to shut off a flow channel. Examples are:

U.S. Pat. No. 5,975,127 to Dray teaches a shut-off valve that comprises a sliding pin moved by an integral piston. The pin contains the flow channel which has exit ports transverse to the pin's axis such that by retracting the pin within the bore shuts off the exit ports. Advancing the pin exposes the exit ports to permit flow. There is no teaching of precompression or suckback functions.

U.S. Pat. No. 5,012,839 to Rogers teaches a heated plastic flow control valve. This comprises a spring-loaded sliding pin that contains the flow channel which has exit ports on the pin's cylindrical surface. Compressing the spring to advance the pin exposes the exit ports to allow flow. In the relaxed state the spring urges the pin to retract and withdraw within the bore thereby closing the exit ports. There is no teaching of precompression or suckback functions.

### SUMMARY OF INVENTION

According to a first broad aspect of the present invention, there is provided an injection nozzle having (i) a nozzle body, defining an inlet channel, (ii) an outlet channel and (iii) a connecting channel therebetween for communicating a working fluid into and out of the nozzle body. A pin is slidably mounted within the nozzle body and having a spigot mounted thereto. The pin is movable between a closed position, where the working fluid is substantially blocked from moving from the inlet channel to the outlet channel, and an open position where the spigot is withdrawn, unblocking the working fluid from moving from the inlet channel to the outlet channel. An actuator is operably connected to the pin to move the pin from the open position to the closed position. Moving the pin from the open position to the closed position generates a region of low pressure in the working fluid in the portion of working fluid trailing the spigot.

### DETAILED DESCRIPTION OF DRAWINGS

A better understanding of the non-limiting embodiments of the present invention (including alternatives and/or variations thereof) may be obtained with reference to the detailed description of the non-limiting embodiments of the present invention along with the following drawings, in which

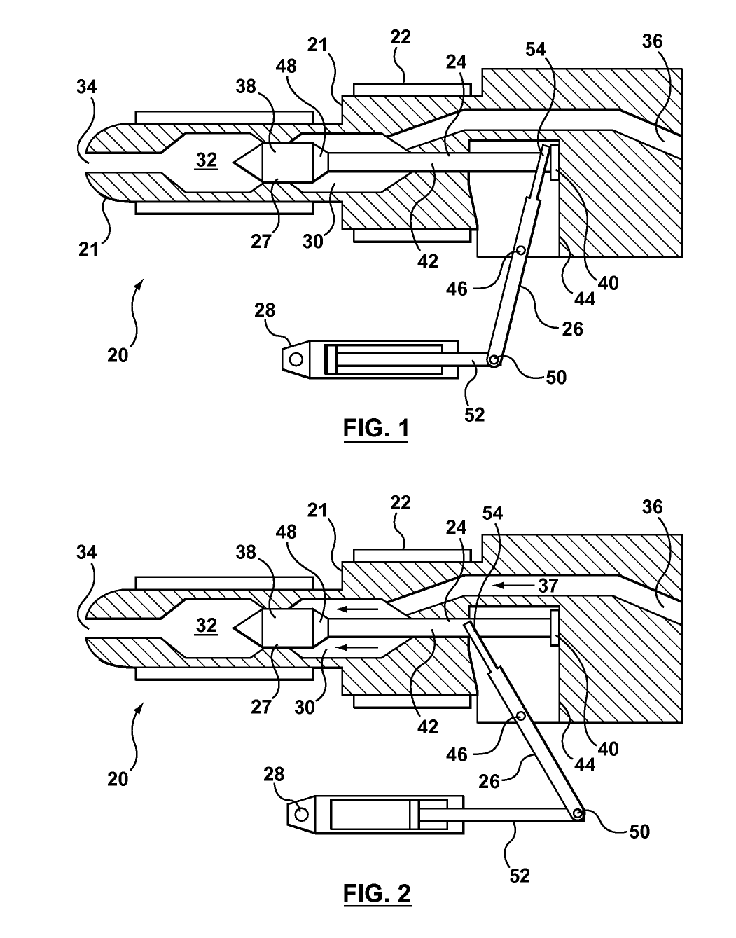

FIG. 1 is a section view of a valve in the closed position, according to a first non-limiting embodiment of the invention;

FIG. 2 is a section view of the valve shown in FIG. 1 prior to opening;

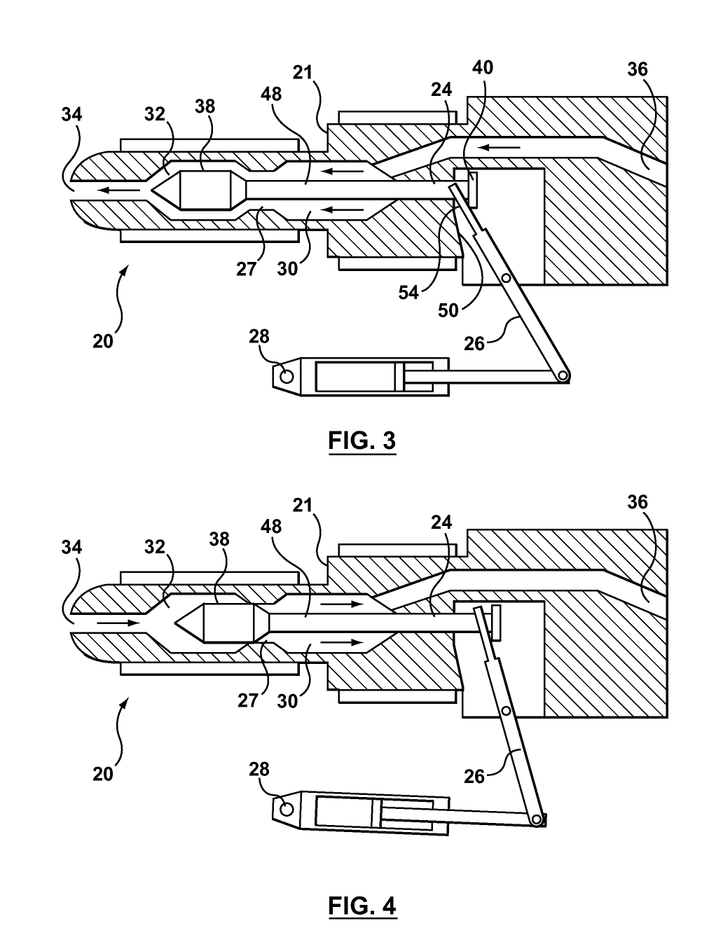

FIG. 3 is a section view of the valve shown in FIG. 1 in the open position;

FIG. 4 is a section view of the valve shown in FIG. 1 in the suckback position;

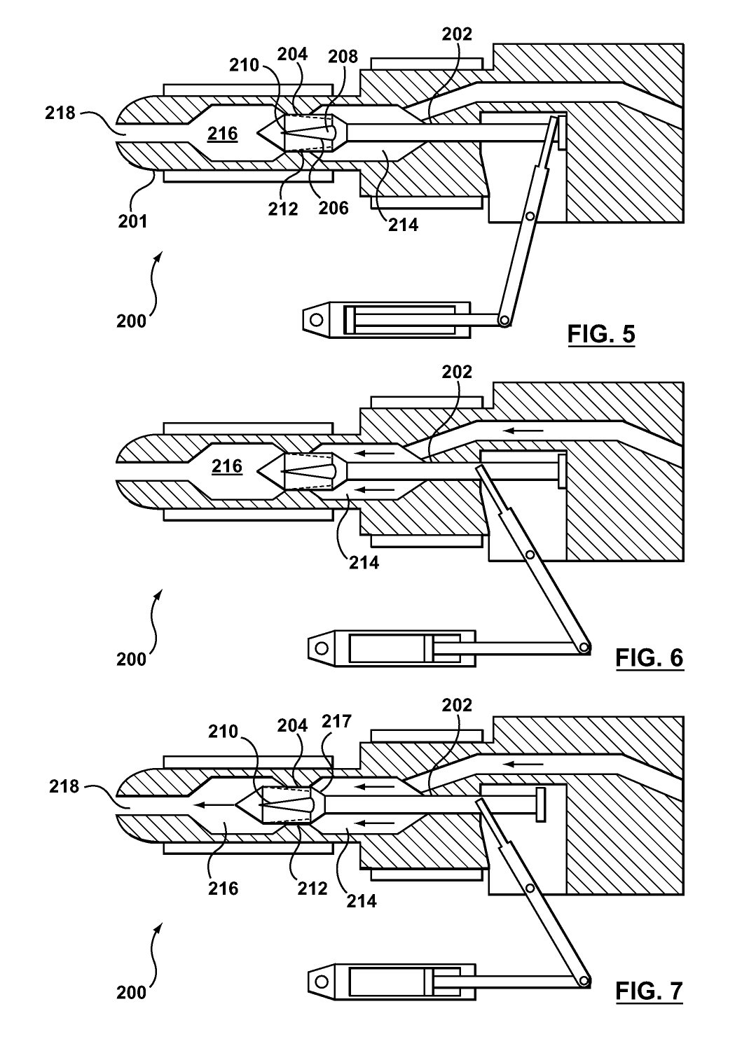

FIG. 5 is a section view of a valve in the closed position, according to a second non-limiting embodiment of the invention;

FIG. 6 is a section view of the valve shown in FIG. 5 prior to opening;

FIG. 7 is a section view of the vale shown in FIG. 5 showing the valve partially open;

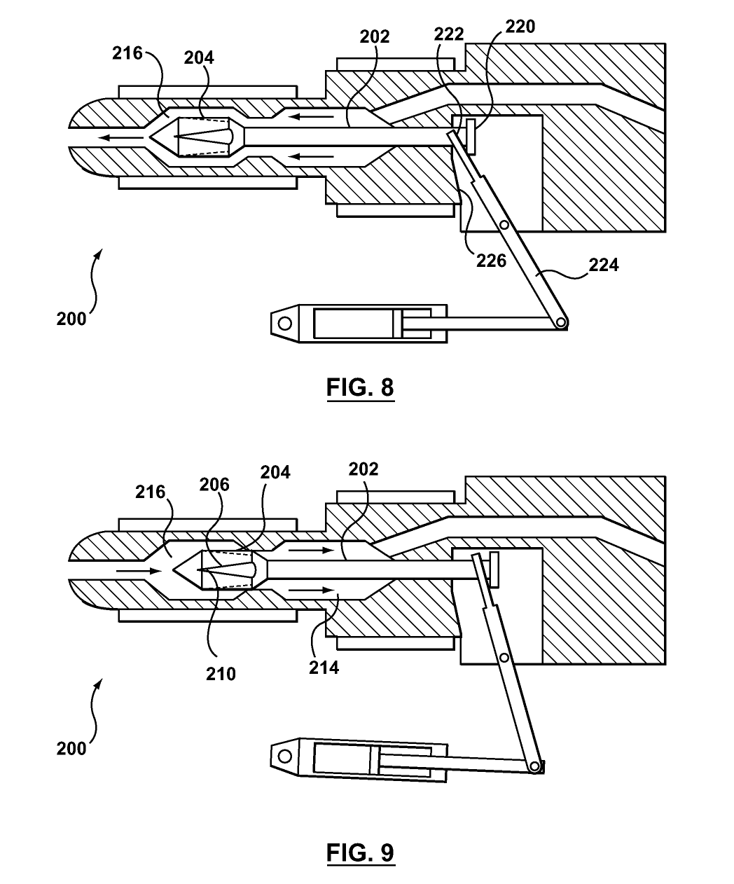

FIG. 8 is a section view of the valve shown in FIG. 5 showing the valve in the open position;

FIG. 9 is a section view of the valve shown in FIG. 5, showing the valve in the suckback position;

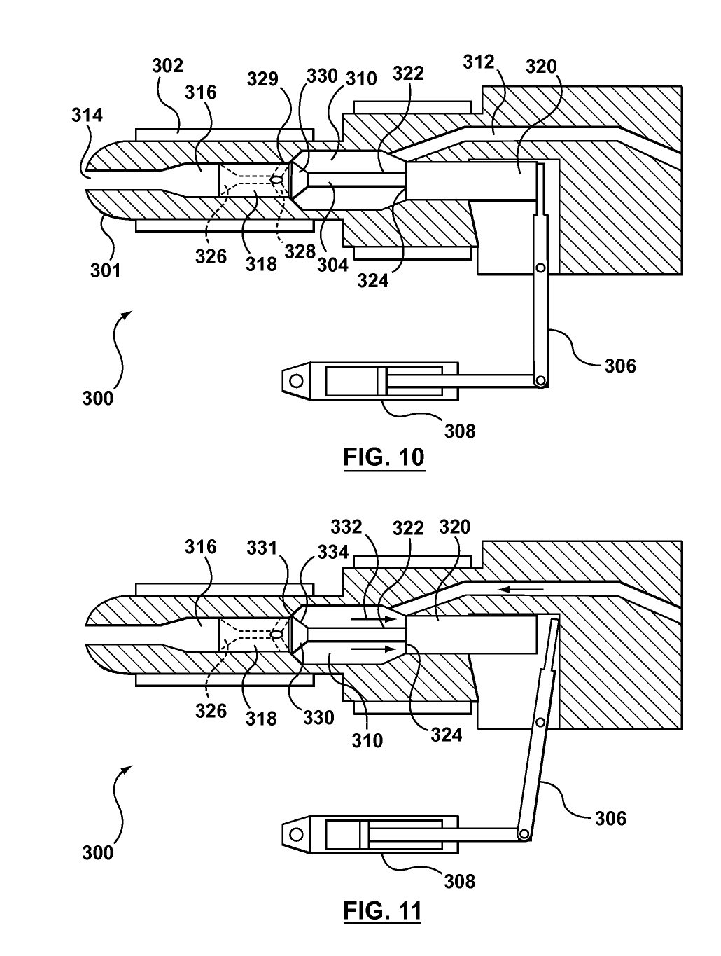

FIG. 10 is a section view of a valve in the closed position, according to a third non-limiting embodiment of the invention;

FIG. 11 is a section view of the valve shown in FIG. 10, in the pre-compression position;

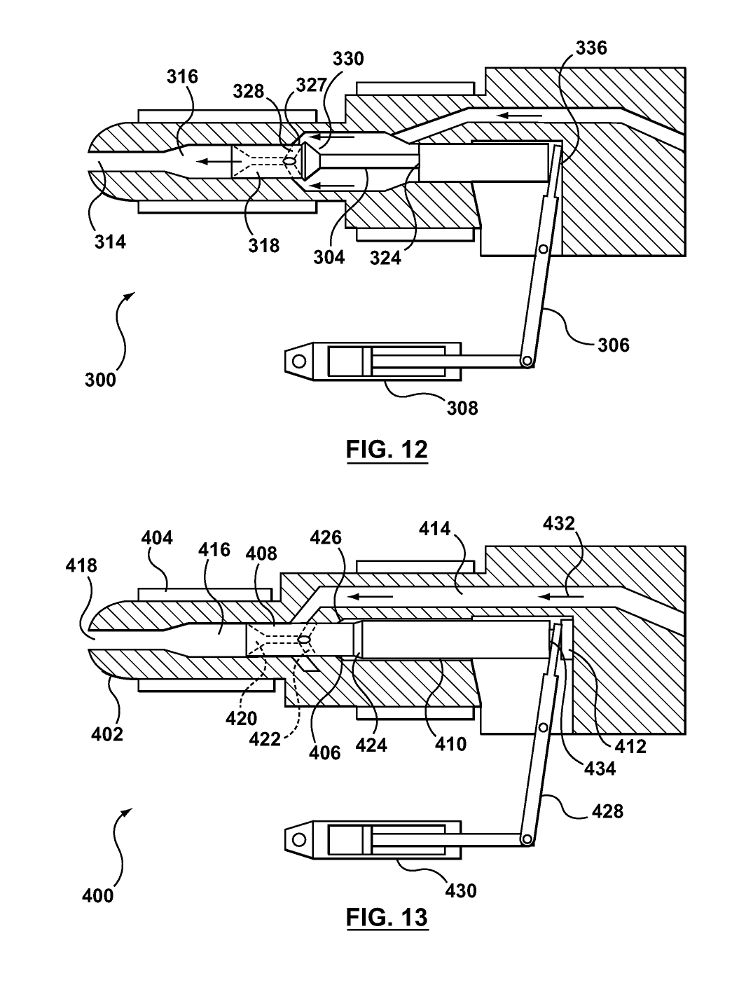

FIG. 12 is a section view of the valve shown in FIG. 10 in the open position;

FIG. 13 is a section view of a valve in the closed position, according to a fourth non-limiting embodiment of the invention;

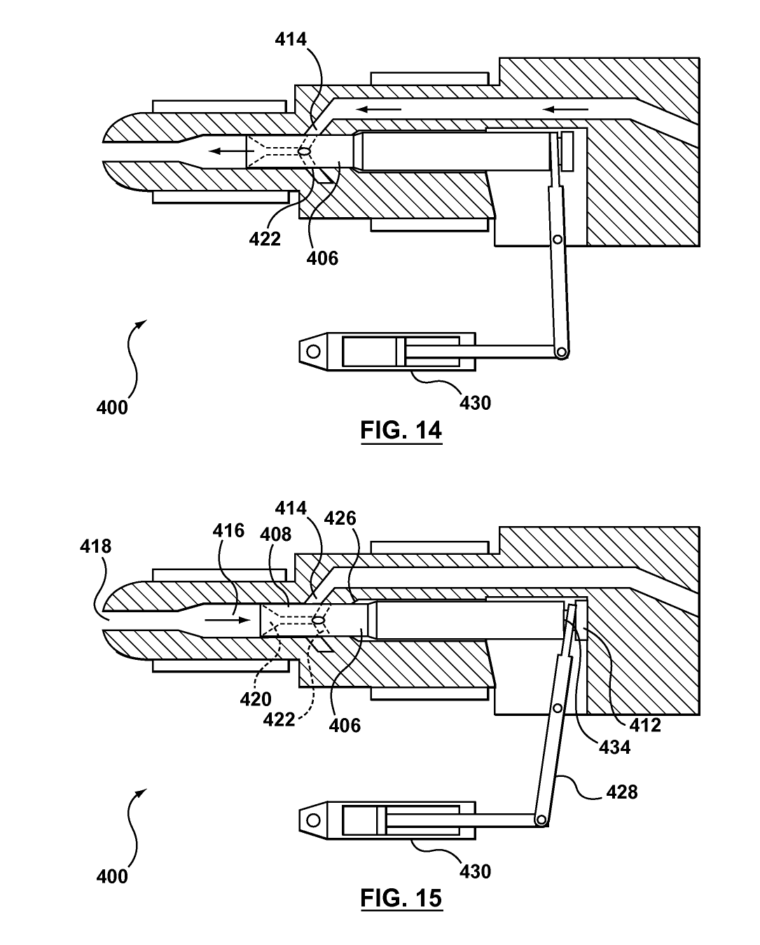

FIG. 14 is a section view of the valve shown in FIG. 13, in the open position; and

FIG. 15 is a section view of the valve shown in FIG. 13 in the suckback position.

### DETAILED DESCRIPTION OF THE NON-LIMITING EMBODIMENTS

With reference to FIG. 1-4, an injection nozzle for an injection molding machine with a shut off valve for a working fluid is shown generally at 20. In the present non-limiting embodiment, the working fluid is typically a molten resin that is suitable for use as a molding material. The injection nozzle 20 comprises a nozzle body 21, maintained at operating temperature by heaters 22, a movable shut off pin 24, a lever 26 and an actuator 28, which in this non-limiting embodiment is a cylinder. The nozzle body 21 has an upstream chamber 30, a downstream chamber 32, an outlet channel 34 and an inlet channel 36. The shut-off pin 24 has a plug to restrict the flow of molten resin between upstream chamber 30 and downstream chamber 32, namely spigot 38, a head 40 and a shaft 42 that connects the two.

In operation the valve is shown in the closed position in FIG. 1. The lever 26 is pivotally mounted to the nozzle body 21 so that it rotates around an axle 46 between a first position (FIG. 1) and a second position (FIG. 2). A first end 50 of the lever 26 is pivotally attached to the output shaft 52 of actuator 28. A second end 54 of lever 26 is free-moving. When the lever 26 is actuated by the actuator 28 towards the first position, the second end 54 of lever 26 urges the head 40 against the back wall 44 of the nozzle body 21, thus maintaining the spigot 38 of the shut-off pin 24 in a connecting channel 27 which connects the upstream chamber 30 with the downstream chamber 32. The spigot 38, located within connecting channel 37, blocks any flow from upstream chamber 30 to downstream chamber 32 via an interface fit between the spigot 38 and the sidewalls of connecting channel 27.

The operating cycle begins by having actuator 28 extend output shaft 52, which in turn causes lever 26 to pivot around axle 46. Pivoting lever 26 causes the second end 54 of lever 26 to pivot towards the second position, away from the head 40 as shown in FIG. 2. Simultaneously (or subsequently), the molding material is introduced into the injection nozzle 20 via inlet channel 36 (as shown by the arrow 37) from an upstream injection unit, not shown. As the molding material fills the upstream chamber 30 it begins to apply pressure to the projecting surfaces of the spigot 38 of the shut-off pin, in particular the conical surface 48. This pressure will continue building and constitutes precompression of the molding material. As pressure builds in the upstream chamber 30 the pressure acting on conical surface 48 causes the shut-off pin 24 to slide forward (i.e., to the left in FIG. 2) overcoming any friction that may have resisted sliding. Eventually the shut-off pin 24 slides sufficiently forward (FIG. 3) to allow the molding material that has filled the upstream chamber 30 to flow through the connecting channel 27 into the downstream chamber 32 and onward through the outlet channel 34 to the mold (not shown).

As soon as the shut-off pin 24 has moved forward sufficiently for its spigot 38 to clear the connecting channel 27 the pressure that was acting on the conical surface 48, and thereby causing the shut-off pin to move, is reduced. As the molding material flows through the injection nozzle 20 the shut-off pin 24 is able to find its own position of equilibrium as pressures acting on its surface become balanced. The shut-off pin 24 is restrained from moving too far towards the outlet channel 34 by its head 40 being trapped against the second end 54 of lever 26 that itself is blocked against the forward wall 50 of the nozzle body 21.

Referring now to FIG. 4, after the mold is filled and the hold portion of the molding cycle has been completed, the injection nozzle 20 begins closing. The lever 26 is actuated against the head 40 to cause the shut-off pin to retract (move to the right in FIG. 4). As the spigot 38 of the shut-off pin enters the connecting channel 27 it causes the molding material downstream of the spigot 38, the molten resin that is in the downstream chamber 32 and in the outlet channel 34 to first decompress and then to be drawn backwards further into the injection nozzle 20. This decompression and suckback action continues while the spigot 38 of the shut-off pin 24 continues to retract within the connecting channel 27. The decompression and suckback of the molding material in the downstream components, machine nozzle, sprue, hot runner and drops, etc. (not shown) means that when, at a later time in the molding cycle, the mold is opened for part removal, and/or the machine nozzle separates from the mold sprue inlet these interfaces will not drool molding material since they will already have been decompressed and the material withdrawn from the orifices at the interfaces. The decompression and suckback action provided by injection nozzle 20 does not preclude the use of conventional means for decompression (i.e. screw retraction). Injection nozzle 20, instead, eliminates the repressurization that can occur with the prior art conventional shut-off pin shutoff designs which pushes the molding material into the hot runner (not shown) when it closes.

FIGS. 5-9 show a second non-limiting embodiment of the invention at an injection nozzle shut off injection nozzle 200. As with the previous embodiment, molten material enters an upstream chamber 214 via an inlet channel 236. This non-limiting embodiment differs from the first in that a spigot 204 of a shut-off pin 202 includes at least one groove cut into the spigot 204. In the presently-illustrated non-limiting embodiment, spigot 204 includes a number of grooves 206. The grooves 206 are preferably shaped in the form of a partial conical surface with the deeper and wider upstream-facing end 208, and the narrower downstream facing end 210. The function of the grooves are to provide a limited flow path for the molding material before the spigot 204 has completely exited a connecting channel 212 during its opening action.

FIG. 5 shows the injection nozzle 200 in the closed position. FIG. 6 shows the injection nozzle 200 closed while precompression of the molding material in an upstream chamber 214 commences.

FIG. 7 shows the injection nozzle 200 partially opened by melt pressure acting on a conical surface 217 of the shut-off pin 202. As shut-off pin 202 advances, the downstream-facing end 210 of each groove 206 is exposed as spigot 204 begins to exit the connecting channel 212 into downstream chamber 216, thereby allowing some molding material to begin flowing from upstream chamber 214 to downstream chamber 216, and then out through an out channel 218. The effect is to cause the pressure to drop in the upstream chamber 214 which in turn slows the rate at which the shut-off pin 202 advances towards its fully opened position.

FIG. 8 shows the shut-off pin 202 in the fully opened position with spigot 204 being located within downstream chamber 216. Shut-off pin 202's forward motion is restrained by its head 220 being trapped against a second end 222 of a lever 224 that itself is blocked against a forward wall 226 of a nozzle body 201.

FIG. 9 shows shut-off pin 202 partially retracted by an actuator 228 to cause decompression and suckback of the material in the downstream components as previously described. The grooves 206 act to modify the rate of this decompression and suckback function since they provide a limited flow channel connecting the upstream chamber 214 and the downstream chamber 216 while the spigot 204 retracts into the connecting channel 212. However, as soon as the downstream-facing end 210 enters the connecting channel 212 there ceases to be this flow path connecting the upstream and downstream chambers 214 and 216 and full effect of the decompression and suckback function is realized. The size shape and number of grooves 206 can be varied to modify the opening and closing performance of the injection nozzle 200.

FIGS. 10-12 show a third non-limiting embodiment of the invention generally at 300, providing precompression. FIG. 10 shows a injection nozzle shut off injection nozzle 300 that comprises a nozzle body 301 maintained at operating temperature by heaters 302, a shut off pin 304 slidably retained within the nozzle body 301 and actuated by an lever 306 that in turn is moved by actuator 308, which in this non-limiting embodiment is a cylinder. The nozzle body 301 has an upstream chamber 310 that is supplied by an inlet channel 312. The injection nozzle 300 also has an outlet channel 314 that connects to a sprue or hot runner system of a mold (not shown). The nozzle body also has connecting channel 316 that connects the chamber upstream with the outlet channel 314 and sized to permit a spigot 318 formed on the shut-off pin 304 to translate therein. The shut-off pin 304 also has a shank 320, and a narrower shaft 322 that connects the shank 320 to the spigot 318. The shank has an exposed annular area 324 that forms part of the wall defining the upstream chamber 310. The spigot 318 contains an internally-formed melt channel 326 therein that exits at the forward end of the spigot. The internally-formed melt channel 326 is supplied by one or more entry channels 328 that have ports 329 on the cylindrical surface of the spigot 318 at the upstream end. The spigot also has a valve seat 330 that comprises a frusto-conical surface having a larger diameter than either that of the spigot 318 or connecting melt channel 316.

FIG. 10 shows the injection nozzle 300 in the closed position in which the actuator 308 is causing the lever 306 to urge the shut-off pin 304 towards outlet channel 314 so that the valve seat 330 is in sealing contact with a corresponding conical sealing surface 331 at the upstream end of the connecting channel 316 in the nozzle body. The ports 329 on entry channels 328 abut against the sidewall of the nozzle body 301.

FIG. 11 shows actuator 308 move a second end 354 on lever 306 away from the shut-off pin 304 so that it can retract. Arrows 332 indicate molding material pressure is building within the upstream chamber 310. The pressure will continue building until the force acting on the annular area 324 of the shank 320 of the shut-off pin 304 causes the shut-off pin 304 to retract. For this effect to occur the annular area 324 of the shank must be greater than the projected area of the conical surface 334 of the shut-off pin 304 adjacent the valve seat 330.

FIG. 12 shows the injection nozzle 300 in the open position. As the shut-off pin 304 is retracted, it partially withdraws the spigot 318 from within the connecting channel 316, thereby exposing the ports 329 of the entry channels 328. This allows the molding material to begin flowing from the upstream chamber 310 through the entry channels 328, internally-formed melt channel 326 and to the outlet channel 314 and into the mold (not shown). The rate at which the spigot 318 is retracted, and hence the rate at which the molding material can begin flowing, can be varied by modifying the respective projected areas of the annular area 324 of the shank and the conical surface 334 of the shut-off pin 304.

When injection nozzle 300 is in the open position, the shut-off pin 304 has retracted until its motion is blocked against the lever 306 that in turned is blocked against a back wall 336 of the nozzle body 301. To close injection nozzle 300, actuator 308 pivots lever 306 so as to slide shut-off pin 304 towards outlet channel 314. With this embodiment, there is minimal decompression or suck-back action.

It is contemplated that the injection nozzle 300 could be adapted to provide a conventional shut-off design with a spigot at the end of the shut-off pin (not shown). This variant would not provide any decompression or suckback upon closure, but would still provide pre-compression without requiring an actuator or other biasing force to maintain the shut-off pin in the closed position.

FIGS. 13-15 show a fourth non-limiting embodiment of the invention, namely injection nozzle shut off injection nozzle 400. Nozzle body 402 is maintained at operating temperature by heaters 404. The injection nozzle 400 includes a slidable shut-off pin 406 that has a spigot 408, a shank 410 and a head 412. The nozzle body 402 includes an inlet channel 414, a connecting channel 416 and an outlet channel 418. The spigot 408 of the shut-off pin 406 contains a melt channel 420 connected to one or more entry channels 422. The entry channels 422 have ports on the cylindrical surface of the spigot 408 at the upstream end. The spigot also has a valve seat 424 that comprises a frusto-conical surface having a larger diameter than that of the spigot 408. The corresponding conical sealing surface 426 for the valve seat 424 is configured in the nozzle body 402 and acts to limit the forward motion of the shut-off pin 406. The head 412 at the shank end of the shut-off pin 406 is configured to trap the actuating lever 428 between opposing first and second head surfaces 434, such that the actuator 430 can move the lever and shut-off pin 406 in both directions positively.

FIG. 13 shows the valve in the closed position with molding material flowing in the inlet channel 414 represented by arrow 432. This allows the molding material to be precompressed to very high levels as the shut-off pin 406 is positively held in the closed position by the actuator 430 and there are no exposed areas for the melt pressure to act against that could cause the shut-off pin 406 to move.

FIG. 14 shows the injection nozzle 400 in the open position in which the actuator 430 has advanced the shut-off pin 406 so that the ports of the entry channels 422 in the spigot 408 are aligned with the inlet channel 414. The rate at which the opening of these ports occurs can be controlled by the rate at which the actuator 430 moves the shut-off pin 406, thus a controlled opening of the valve can be effected.

FIG. 15 shows the injection nozzle 400 in the decompression or suckback position in which the actuator 430 is positively retracting the shut-off pin 406. A partial decompression and suckback is effected as soon as the shut-off pin 406 begins to retract and full decompression and suckback are effected as soon as the inlet channel ports move past the inlet channel 414. The rates at which molding material filling during injection, decompression and suckback occur can be controlled by the positive actuation of the shut-off pin 406 in each respective direction.

Non-limiting embodiments of the present invention may provide a shut-off valve that allows for pre-compression of a molding material. Non-limiting embodiments of the present invention may provide a shut-off valve that allows for decompression and suck-back to occur at the end of an injection cycle. Furthermore, non-limiting embodiments of the present invention may provide an adjustable rate for the flow of the injection material and suckback.

The description of the non-limiting embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the non-limiting embodiments, it will be apparent that modifications and enhancements are possible without departing from the concepts as described. Therefore, what is to be protected by way of letters patent are limited only by the scope of the following claims.

What is claimed is:

1. An injection nozzle, comprising:
a nozzle body, defining an inlet channel, an outlet channel and a connecting channel therebetween for communicating a working fluid into and out of the nozzle body;
a shut-off pin, slidably mounted within the nozzle body, and movable between a closed position and an open position;
a spigot mounted to the shut-off pin, the spigot blocking the working fluid from moving through the connecting channel when the shut-off pin is in the closed position, and further not blocking the working fluid from moving through the connecting channel when the shut-off pin is in the open position;
wherein moving the shut-off pin from the open position to the closed position generates a region of low pressure in the working fluid in a portion of the working fluid trailing the spigot.

2. The injection nozzle of claim 1, wherein the spigot provides an interface fit between the spigot and a sidewall of the connecting channel when the shut-off pin is in the closed position, thereby blocking the working fluid from moving through the connecting channel.

3. The injection nozzle of claim 2, wherein while the shut-off pin is in the closed position, a projecting surface on the spigot resists the pressure applied by the working fluid so that the working fluid is precompressed.

4. The injection nozzle of claim 3, wherein the working fluid is operable to act on the projecting surface of the spigot as to move the shut-off pin from the closed position to the open position once a preferred level of precompression has occurred in the working fluid.

5. The injection nozzle of claim 4, wherein the shut-off pin is maintained in the open position by an equilibrium of force applied by the working fluid to the spigot.

6. The injection nozzle of claim 5, further comprising an actuator, operably connected to the shut-off pin to move the shut-off pin from the open position to the closed position.

7. The injection nozzle of claim 7, wherein an actuator is operable to actuate the shut-off pin via a lever.

8. The injection nozzle of claim 7, wherein the lever is pivotally mounted to the nozzle body, and includes a first end that is pivotally attached to the actuator.

9. The injection nozzle of claim 8, wherein a second end of the lever is operable to actuate a head on a proximal end of the shut-off pin, thereby moving the shut-off pin towards the closed position.

10. The injection nozzle of claim 9, wherein the second end of the lever retains the shut-off pin the closed position by abutting against the head.

11. The injection nozzle of claim 10, wherein the actuator is operable to move the second end of the lever away from the head, thereby permitting the shut-off pin to move to the open position.

12. The injection nozzle of claim 11, wherein the second end of the lever intersects a plane of movement of the head, thereby preventing the shut-off pin from moving beyond the open position.

13. The injection nozzle of claim 5, wherein the nozzle body further defines an upstream chamber between the inlet channel and the connecting channel.

14. The injection nozzle of claim 13, wherein the nozzle body further defines a downstream chamber between the connecting channel and the outlet channel.

15. The injection nozzle of claim 14, wherein the spigot moves from the connecting channel to the downstream chamber when the shut-off pin is moved from the closed position to the open position.

16. The injection nozzle of claim 4, wherein the spigot defines a limited flow path, the limited flow path allowing partial movement of the working fluid within the connecting channel prior to the spigot moving completely from the closed position to the open position.

17. The injection nozzle of claim 16, wherein the limited flow path is defined by at least one groove that is cut in a surface of the spigot.

18. The injection nozzle of claim 17, wherein the at least one groove is a partial conical surface, the partial conical surface being narrower towards a downstream-facing end and wider towards an upstream-facing end.

19. The injection nozzle of claims 4, wherein the spigot includes an internally-formed melt channel that communicates with the outlet channel, and further includes at least one port distributed around a sidewall of the spigot, the at least one port communicating with a melt channel.

20. The injection nozzle of claim 19, wherein the at least one port is not in communication with the working fluid from the inlet channel while the shut-off pin is in the closed position, and the at least one port is in communication with the working fluid from the inlet channel while the shut-off pin is in the open position.

21. The injection nozzle of claim 20, wherein the at least one port abuts against the sidewall of the connecting channel while the shut-off pin is in the closed position, and the at least one port exits the connecting channel while the shut-off pin is in the open position.

22. The injection nozzle of claim 21, wherein a valve seat on the shut-off pin abuts against a sealing surface adjacent the connecting channel when the shut-off pin is in the closed position, thereby preventing the shut-off pin from moving further than the closed position towards the outlet channel.

23. The injection nozzle of claim 22, wherein the shut-off pin further includes a shank having an annular area that is larger in diameter than the valve seat, the annular area defining the portion of the sidewall of an upstream chamber.

24. The injection nozzle of claim 23, wherein the working fluid in the annular area applies pressure to the annular area, the pressure urging the shut-off pin towards the open position.

25. The injection nozzle of claim 23, wherein an actuator is operable to actuate the shut-off pin via a lever to either of the open position and the closed position.

26. The injection nozzle of claim 25, wherein a second end of the lever retains the shut-off pin the closed position by abutting against a first head surface on a head.

27. The injection nozzle of claim 26, wherein the actuator is operable to move the second end of the lever to engage a second head surface on the head, thereby permitting the shut-off pin to move to the open position.

28. The injection nozzle of claim 20, wherein the surface area of a spigot portion of the internally-formed melt channel is less than the surface area of a valve seat.

29. The injection nozzle of claim 20, wherein the at least one port abuts against the sidewall of the connecting channel while the shut-off pin is in the closed position, and the at least one port is in communication with the inlet channel while the shut-off pin is in the open position.

30. The injection nozzle of claim 29, wherein a valve seat on the shut-off pin abuts against a conical sealing surface in the nozzle body when the shut-off pin is in the closed position, thereby preventing the shut-off pin from moving further than the closed position towards the outlet channel.

31. The injection nozzle of claim 30, wherein an actuator is operable to reversibly actuate the shut-off pin via a lever towards either the open position or the closed position.

32. The injection nozzle of claim 31, wherein the actuator is operable to move the shut-off pin a partial distance towards one of the open position and the closed position.

33. The injection nozzle of claim 32, wherein the actuator is operable to move the shut-off pin towards one of the open position and the closed position at a variable speed.

34. The injection nozzle of claim 30, wherein the surface area of a spigot portion of the internally-formed melt channel is less than the surface area of the valve seat.

36. An injection nozzle, comprising:
a nozzle body, being attachable to a barrel of molding-system extruder; and
a shut-off pin being actuatably movable in the nozzle body, the shut-off pin having a spigot.

37. An injection nozzle, comprising:
a nozzle body, being attachable to a barrel of molding-system extruder; and
a shut-off pin being actuatably movable in the nozzle body, the shut-off pin having: a spigot generating, responsive to closure of the shut-off pin, a low-pressure region in a fluid molding material trailing the spigot.

38. The injection nozzle of claim 37, wherein:
the spigot is configured to: (i) once the shut-off pin is made to move to a closed position, block flow of the fluid molding material through the nozzle body, (ii) once the shut-off pin is made to move to an open position, permit flow of the fluid molding material through the nozzle body.

39. The injection nozzle of claim 37, further comprising:
an actuator operably connected to the shut-off pin, the actuator configured to move the shut-off pin from the open position to the closed position.

40. An injection nozzle, comprising:
a nozzle body, being attachable to a barrel of molding-system extruder; and
a shut-off pin being actuatably movable in the nozzle body, the shut-off pin having a spigot generating, responsive to closure of the shut-off pin, a low-pressure region in a fluid molding material trailing the spigot, wherein:
the spigot is configured to: (i) once the shut-off pin is made to move to a closed position, block flow of the fluid molding material through the nozzle body, (ii) once the shut-off pin is made to move to an open position, permit flow of the fluid molding material through the nozzle body, and
the shut-off pin is actuatably controllable by an actuator operably connected to the shut-off pin, the actuator configured to move the shut-off pin from the open position to the closed position.

41. An injection molding machine having at least one injection nozzle in accordance with the injection nozzle of any one of claims 1 to 40.
